(19) United States
(12) Patent Application Publication
(10) Pub. No.: US 2026/0077311 A1
(43) Pub. Date: Mar. 19, 2026

(54) INTEGRATED CATALYTIC REACTOR, AND EXHAUST GAS INTEGRATED TREATMENT SYSTEM INCLUDING THE SAME

(71) Applicant: SAMSUNG ELECTRONICS CO., LTD., Suwon-si (KR)

(72) Inventors: Bongsoo CHOI, Suwon-si (KR); Seungbin CHOI, Hwasung-si (KR); Youngmin Kim, Hwasung-si (KR); Heejae LEE, Hwasung-si (KR); Dajeong LIM, Suwon-si (KR); Sunsik JUNG, Hwasung-si (KR); Jaehyun KIM, Hwasung-si (KR); Kyeongmin BAEK, Suwon-si (KR); Joungwoo HAN, Suwon-si (KR); Sungwoong Bae, Suwon-si (KR); Byunghyuck LEE, Suwon-si (KR); Jongmyeong LEE, Suwon-si (KR); Juhyeong JUNG, Suwon-si (KR); Hanyoung CHO, Suwon-si (KR); Iljeong HEO, Suwon-si (KR)

(73) Assignees: SAMSUNG ELECTRONICS CO., LTD., Suwon-si (KR); CTP KOREA Co., Ltd, Hwasung-Si (KR)

(21) Appl. No.: 19/291,045

(22) Filed: Aug. 5, 2025

(30) Foreign Application Priority Data
Sep. 13, 2024 (KR) 10-2024-0126195
Nov. 29, 2024 (KR) 10-2024-0175823

(51) Int. Cl. B01D 53/86; B01D 39/20; B01D 53/00; B01D 53/34

(52) U.S. Cl. CPC B01D 53/86; B01D 39/2041; B01D 53/005; B01D 53/343; B01D 2255/1021; B01D 2255/20761; B01D 2258/0216

(57) ABSTRACT

An integrated catalytic reactor includes a heat source configured to heat an exhaust gas including an organic material and an alkaline material, a filter configured to filter a secondary pollutant in the exhaust gas that is heated by the heat source, an airflow stabilizer configured to adjust a flow direction and a flow speed of the exhaust gas that is filtered by the filter, and a catalytic assembly configured to at least partially remove the organic material and the alkaline material in the exhaust gas that flows into the catalytic assembly from the airflow stabilizer.

### CROSS-REFERENCE TO RELATED APPLICATION

This application is based on and claims priority under 35 U.S.C. § 119 to Korean Patent Application Nos. 10-2024-0126195, filed on Sep. 13, 2024, and 10-2024-0175823, filed on Nov. 29, 2024, in the Korean Intellectual Property Office, the disclosures of which are incorporated by reference herein in their entirety.

### BACKGROUND

The present disclosure relates to an integrated catalytic reactor and an exhaust gas integrated treatment system including the integrated catalytic reactor, and more particularly, to an integrated catalytic reactor for exhaust gas from a semiconductor and an exhaust gas integrated treatment system including the integrated catalytic reactor.

Exhaust gases generated during semiconductor manufacturing processes may contain alkaline materials and organic materials. In general, alkaline materials, such as ammonia, are removed by wet methods, while organic materials, such as isopropyl alcohol, may be removed by direct combustion methods (e.g., a regenerative thermal oxidizer (RTO)) after concentration treatment. However, the removal of organic materials by the direct combustion methods may require a significant amount of energy and generate secondary pollutants, such as nitrogen oxides. Also, the removal of alkaline materials by the wet methods may produce wastewater due to wet treatment. In addition, when the exhaust gas is treated in the manner described above, the alkaline materials and the organic materials have to be treated by using separate facilities. That is, different compounds have to be removed by separate treatments, which may require wide installation space for the facilities and cause difficulty in maintaining the facilities.

Information disclosed in this Background section has already been known to or derived by the inventors before or during the process of achieving the embodiments of the present application, or is technical information acquired in the process of achieving the embodiments. Therefore, it may contain information that does not form the prior art that is already known to the public.

### SUMMARY

One or more example embodiments provide an integrated catalytic reactor that may be capable of simultaneously treating alkaline materials and organic materials contained in exhaust gases and an exhaust gas integrated treatment system including the integrated catalytic reactor.

Additional aspects will be set forth in part in the description which follows and, in part, will be apparent from the description, or may be learned by practice of the presented embodiments.

According to an aspect of an example embodiment, an integrated catalytic reactor may include a heat source configured to heat an exhaust gas including an organic material and an alkaline material, a filter configured to filter a secondary pollutant in the exhaust gas that is heated by the heat source, an airflow stabilizer configured to adjust a flow direction and a flow speed of the exhaust gas that is filtered by the filter, and a catalytic assembly configured to at least partially remove the organic material and the alkaline material in the exhaust gas that flows into the catalytic assembly from the airflow stabilizer.

According to an aspect of an example embodiment, an exhaust gas integrated treatment system configured to treat an exhaust gas including an organic material and an alkaline material may include a concentrator configured to concentrate the exhaust gas, and an integrated catalytic reaction system configured to at least partially remove the organic material and the alkaline material from the concentrated exhaust gas, where the integrated catalytic reaction system includes an integrated catalytic reactor including a heat source configured to heat the exhaust gas including the organic material and the alkaline material, a filter configured to filter a secondary pollutant in the exhaust gas that is heated by the heat source, an airflow stabilizer configured to adjust a flow direction and a flow speed of the exhaust gas that is filtered by the filter, and a catalytic assembly configured to at least partially remove the organic material and the alkaline material in the exhaust gas that flows into the catalytic assembly from the airflow stabilizer.

According to an aspect of an example embodiment, an integrated catalytic reactor may include a heat source including an electric heater configured to heat an exhaust gas including an organic material and an alkaline material, a filter configured to filter a secondary pollutant in the exhaust gas that is heated by the heat source, an airflow stabilizer including a first guide vane configured to change a flow direction of the exhaust gas that is filtered by the filter, a plurality of second guide vanes at higher vertical levels than a vertical level of the first guide vane and configured to change the flow direction of the exhaust gas that is filtered by the filter, a plurality of first straighteners in a first straightener region and arranged in a horizontal direction, the plurality of first straighteners configured to adjust a flow speed of the exhaust gas, and a plurality of second straighteners in a second straightener region arranged in the horizontal direction, the plurality of second straighteners configured to adjust the flow speed of the exhaust gas, and a catalytic assembly including a body, a first catalytic layer on the body and configured to at least partially remove the organic material and the alkaline material in the exhaust gas, and a second catalytic layer on the first catalytic layer and configured to at least partially remove the alkaline material in the exhaust gas.

### BRIEF DESCRIPTION OF DRAWINGS

The above and other aspects, features, and advantages of certain example embodiments of the present disclosure will be more apparent from the following description taken in conjunction with the accompanying drawings, in which:

FIG. 1 is a block diagram illustrating an exhaust gas integrated treatment system according to one or more embodiments;

FIG. 2 is a block diagram illustrating an integrated catalytic reaction system according to one or more embodiments;

FIG. 3 is a cross-sectional view illustrating an integrated catalytic reaction system according to one or more embodiments;

FIG. 4 is a cross-sectional view illustrating a heat source of an integrated catalytic reactor according to one or more embodiments;

FIG. 5 is a diagram illustrating a filter of an integrated catalytic reactor according to one or more embodiments;

FIG. 6 is a cross-sectional view illustrating an airflow stabilizer of an integrated catalytic reactor according to one or more embodiments;

FIG. 7 is a cross-sectional view illustrating a catalytic assembly of an integrated catalytic reactor according to one or more embodiments;

FIG. 8A is a diagram illustrating the results of a heat flow analysis of a heat source according to a comparative example;

FIG. 8B is a diagram illustrating the results of a heat flow analysis of a heat source according to one or more embodiments;

FIG. 9A is a diagram illustrating the results of a heat flow analysis of an airflow stabilizer according to a comparative example;

FIG. 9B is a diagram illustrating the results of a heat flow analysis of an airflow stabilizer according to one or more embodiments;

FIG. 10A is a diagram illustrating the results of an airflow analysis of an airflow stabilizer according to a comparative example;

FIG. 10B is a diagram illustrating the results of an airflow analysis of an airflow stabilizer according to one or more embodiments;

FIG. 11A is a graph illustrating treatment efficiency of a catalytic assembly for an exhaust gas according to an inlet temperature of the exhaust gas, according to one or more embodiments;

FIG. 11B is a graph illustrating treatment efficiency of a catalytic assembly for an exhaust gas according to a concentration ratio of the exhaust gas, according to one or more embodiments; and

FIG. 12 is a cross-sectional view illustrating an integrated catalytic reaction system according to one or more embodiments.

### DETAILED DESCRIPTION

Hereinafter, example embodiments of the disclosure will be described in detail with reference to the accompanying drawings. The same reference numerals are used for the same components in the drawings, and redundant descriptions thereof will be omitted. The embodiments described herein are example embodiments, and thus, the disclosure is not limited thereto and may be realized in various other forms.

As used herein, expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

It will be understood that when an element or layer is referred to as being “over,” “above,” “on,” “below,” “under,” “beneath,” “connected to” or “coupled to” another element or layer, it can be directly over, above, on, below, under, beneath, connected or coupled to the other element or layer or intervening elements or layers may be present. In contrast, when an element is referred to as being “directly over,” “directly above,” “directly on,” “directly below,” “directly under,” “directly beneath,” “directly connected to” or “directly coupled to” another element or layer, there are no intervening elements or layers present.

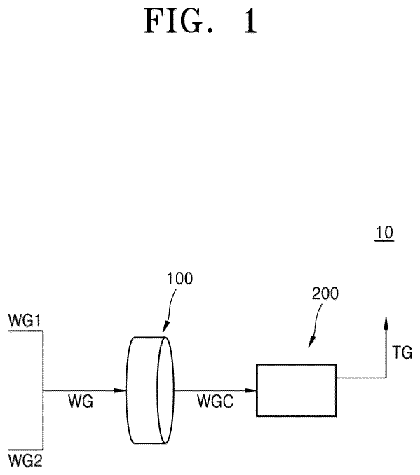

FIG. 1 is a block diagram illustrating an exhaust gas integrated treatment system 10 according to one or more embodiments.

Referring to FIG. 1, the exhaust gas integrated treatment system 10 may include a concentrator 100 and an integrated catalytic reaction system 200. The concentrator 100 may be configured to concentrate an exhaust gas WG generated during a semiconductor manufacturing process. The semiconductor manufacturing process may include, for example, a photolithography process, a deposition process, and an etching process. For example, the semiconductor manufacturing process may represent the photolithography process, and the exhaust gas WG may include a photoresist material generated after the photolithography process is performed.

The exhaust gas WG may include a first exhaust material WG1 and a second exhaust material WG2. The first exhaust material WG1 may include, for example, an alkaline material such as ammonia (NH₃), and the second exhaust material WG2 may include, for example, an organic material such as a volatile organic compound (VOC). That is, the exhaust gas WG may represent a composite exhaust gas including both the alkaline material and the organic material. The concentrator 100 may include an adsorbent layer that includes, for example, zeolite, alumina (Al₂O₃), porous silica (SiO₂), carbon-based adsorbents, and the like. The exhaust gas WG flowing into the concentrator 100 may be concentrated by the concentrator 100 and converted to a concentrated exhaust gas WGC, which may flow from the concentrator 100 to the integrated catalytic reaction system 200. In one or more embodiments, a concentration ratio of the exhaust gas WG concentrated by the concentrator 100 may be from about 7:1 to about 10:1.

The integrated catalytic reaction system 200 may be configured to treat the concentrated exhaust gas WGC flowing therein and discharge a treated gas TG to the outside. The treated gas TG may represent a gas obtained by removing, or at least partially removing, the alkaline material and the organic material from the concentrated exhaust gas WGC.

The concentrator 100 and the integrated catalytic reaction system 200 may be disposed in a multilayer structure. For example, the concentrator 100 may be disposed on the integrated catalytic reaction system 200 to overlap the integrated catalytic reaction system 200 in a vertical direction.

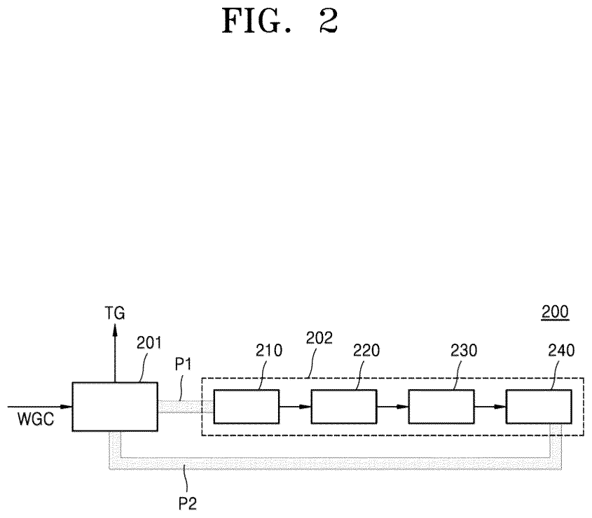

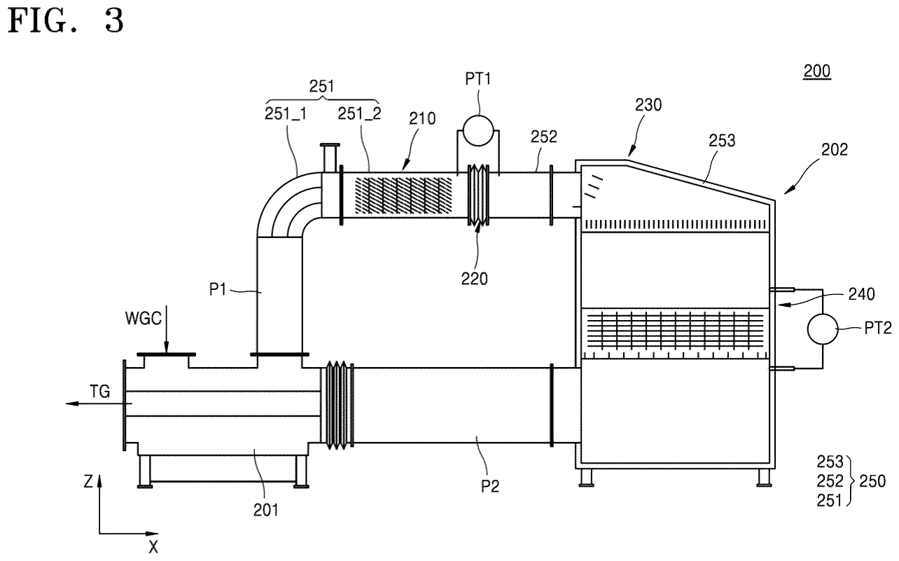

FIG. 2 is a block diagram illustrating the integrated catalytic reaction system 200 according to one or more embodiments. FIG. 3 is a cross-sectional view illustrating the integrated catalytic reaction system 200 according to one or more embodiments.

Referring to FIGS. 2 and 3, the integrated catalytic reaction system 200 may include a heat exchanger 201 and the integrated catalytic reactor 202. The heat exchanger 201 and the integrated catalytic reactor 202 may communicate with each other via a first pipe P1 and a second pipe P2.

The heat exchanger 201 may be configured to, after treatment of the concentrated exhaust gas WGC via the integrated catalytic reactor 202, collect heat energy used in this treatment.

In one or more embodiments, the integrated catalytic reaction system 200 may not include the heat exchanger 201. For example, after treatment of the concentrated exhaust gas WGC via the integrated catalytic reactor 202, a subsequent process may be performed utilizing the heat energy used in this treatment. In this case, the heat exchanger 201 may be omitted as illustrated in FIGS. 2 and 3.

The integrated catalytic reactor 202 may include a heat source 210, a filter 220, an airflow stabilizer 230, the catalytic assembly 240, and a frame structure 250, which may include a first frame 251, a second frame 252 and a third frame.

The heat source 210 may be located inside a second sub-frame 251_2 of the first frame 251. The heat source 210 may be configured to heat the concentrated exhaust gas WGC, flowing in from the heat exchanger 201 via the first pipe P1, to a catalytic reaction temperature. The concentrated exhaust gas WGC flowing into the heat source 210 may be heated by the heat source 210 to a temperature of about 380° C. to about 420° C.

In one or more embodiments, the heat source 210 may include an electric heater. Since the heat source 210 may utilize the electric heater to heat the concentrated exhaust gas WGC, no separate nitrogen oxide and carbon dioxide may be generated during heating of the concentrated exhaust gas WGC.

The filter 220 may be located between a first frame 251 and a second frame 252. The filter 220 may be configured to filter out a secondary pollutant, such as silicon oxide (SiO₂), in the concentrated exhaust gas WGC that is heated by the heat source 210. In one or more embodiments, the filter 220 may include a metal mesh grid filter including stainless steel or a ceramic filter. The filter 220 may collect and trap the silicon oxide in the concentrated exhaust gas WGC via the metal mesh grid filter including stainless steel or the ceramic filter and filter out the secondary pollutant, such as silicon oxide, from the concentrated exhaust gas WGC.

In one or more embodiments, the filter 220 may include one to five (or more) metal mesh grid filters. The number of metal mesh grid filters in the filter 220 may be adjusted as needed. When the filter 220 includes a plurality of metal mesh grid filters, the plurality of metal mesh grid filters may be arranged obliquely relative to each other while forming an inclination angle. That is, the plurality of metal mesh grid filters may be rotationally offset from each other at one or more predetermined rotation angles.

In one or more embodiments, the surface of the metal mesh grid filter including stainless steel may be coated with a ceramic material. For example, when the concentration of silicon oxide in the concentrated exhaust gas WGC flowing into the filter 220 is maintained constant at a relatively low level, the filter 220 including the metal mesh grid filter having the surface coated with the ceramic material may be used to filter out the silicon oxide. On the other hand, when the concentration of silicon oxide in the concentrated exhaust gas WGC flowing into the filter 220 instantaneously increases to a relatively high level, the filter 220 including the metal mesh grid filter having a surface not separately coated may be used to filter out the silicon oxide.

In one or more embodiments, the ceramic filter may have a honeycomb shape. However, embodiments are not limited thereto.

A first pressure sensor PT1 may be located in and/or on the second frame 252. The first pressure sensor PT1 may measure the difference in pressure between the front end and the rear end of the filter 220. The difference in pressure therebetween measured by the first pressure sensor PT1 may be used to determine when filters in the filter 220 are to be replaced. For example, when the differential pressure value between the front end and the rear end of the filter 220 measured by the first pressure sensor PT1 increases by 50% or more from the differential pressure value measured by the first pressure sensor PT1 immediately after replacement of a filter in the filter 220, the filter in the filter 220 may be replaced.

The airflow stabilizer 230 may be located inside a third frame 253. The airflow stabilizer 230 may be configured to adjust the flow direction and the flow speed of the concentrated exhaust gas WGC treated in the filter 220 so that the concentrated exhaust gas WGC uniformly flows to the upper surface of the catalytic assembly 240. In one or more embodiments, the average linear velocity of the concentrated exhaust gas WGC flowing into the catalytic assembly 240 may be about 0.6 m/s to about 1.0 m/s. In one or more embodiments, the average spatial velocity of the concentrated exhaust gas WGC flowing into the catalytic assembly 240 may be from about 5300 h⁻¹ to about 7500 h⁻¹.

The catalytic assembly 240 may be disposed below the airflow stabilizer 230 inside the third frame 253 such that the catalytic assembly 240 overlaps the airflow stabilizer 230 in a vertical direction (e.g., the Z direction). The catalytic assembly 240 may be configured to treat, by adsorption and reduction, the alkaline material and the organic material in the concentrated exhaust gas WGC flowing via the airflow stabilizer 230.

A second pressure sensor PT2 may be located on and/or in the third frame 253. The second pressure sensor PT2 may measure the difference in pressure between the front end and the rear end of the catalytic assembly 240.

The frame structure 250 may provide a space in which the heat source 210, the filter 220, the airflow stabilizer 230, and the catalytic assembly 240 of the integrated catalytic reactor 202 are arranged. The frame structure 250 may generally have an L-shape that is rotated by 180 degrees. The frame structure 250 may include the first frame 251, the second frame 252, and the third frame 253. The first frame 251 may include a first sub-frame 251_1 and the second sub-frame 251_2. The first sub-frame 251_1 may connect the second sub-frame 251_2 to the first pipe P1. The first sub-frame 251_1 may have an elbow shape. The second sub-frame 251_2 may extend in a horizontal direction (e.g., the X direction). The heat source 210 may be located inside the second sub-frame 251_2. The second frame 252 may be spaced apart from the first frame 251 with the filter 220 therebetween. The second frame 252 may extend in the horizontal direction (e.g., the X direction). The third frame 253 may communicate with the second frame 252. The airflow stabilizer 230 and the catalytic assembly 240 may be arranged inside the third frame 253. The third frame 253 may extend in the vertical direction (e.g., the Z direction).

The integrated catalytic reactor 202 according to one or more embodiments may include the heat source 210, the filter 220, the airflow stabilizer 230, and the catalytic assembly 240. In one or more embodiments, since the heat source 210 may include the electric heater, no separate pollutants, such as nitrogen oxide and carbon dioxide, are generated during the heating of the concentrated exhaust gas WGC. Also, the secondary pollutants, such as silicon oxide, may be removed from the concentrated exhaust gas WGC by the filter 220, and the organic material and the alkaline material in the concentrated exhaust gas WGC may be removed together by the catalytic assembly 240. Accordingly, the exhaust gas integrated treatment system 10 may be installed in a small area because it is not necessary to equip separate facilities for respectively removing the organic material and the alkaline material in the concentrated exhaust gas WGC. Both the organic material and the alkaline material in the concentrated exhaust gas WGC may be removed by a single facility, and thus, the economic efficiency of a treatment process for the concentrated exhaust gas WGC may be improved.

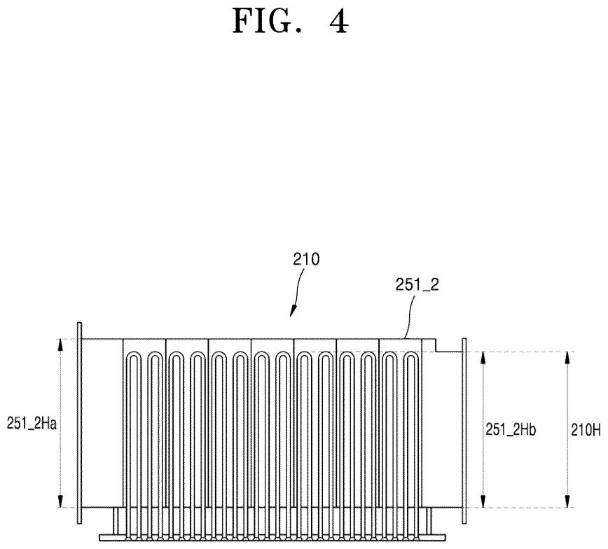

Referring to FIGS. 4, 5, 6, and 7, each component of the integrated catalytic reactor 202 is described below in more detail.

FIG. 4 is a cross-sectional view illustrating the heat source 210 of the integrated catalytic reactor 202 according to one or more embodiments.

Referring to FIG. 4, the heat source 210 may include an electric heater. In one or more embodiments, a vertical length 251_2Ha of an inlet of the heat source 210 may be greater than a vertical length 210H of an electric heater of the heat source 210. However, embodiments are not limited thereto, and the vertical length 251_2Ha of the inlet of the heat source 210 may be equal or substantially equal to the vertical length 210H of the electric heater of the heat source 210. In one or more embodiments, a vertical length 251_2Hb of an outlet of the heat source 210 may be equal or substantially equal to the vertical length 210H of the electric heater of the heat source 210. Since the vertical length 251_2Hb of the outlet of the heat source 210 is equal (or substantially equal) to the vertical length 210H of the electric heater of the heat source 210, the total area of the outlet of the heat source 210 may be uniformly heated by the electric heater. Accordingly, the concentrated exhaust gas WGC flowing into the filter 220 via the outlet may also have a uniform temperature throughout.

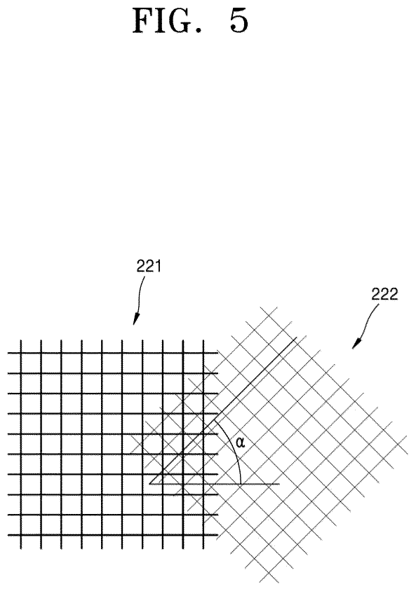

FIG. 5 is a diagram illustrating the filter 220 (see FIG. 2) of the integrated catalytic reactor 202 according to one or more embodiments. Specifically, FIG. 5 is a diagram illustrating the filter 220 (see FIG. 2), which includes the plurality of metal mesh grid filters described with reference to FIGS. 2 and 3.

Referring to FIG. 5, when the filter 220 (see FIG. 2) includes two metal mesh grid filters, a first filter 221 and a second filter 222 may be arranged obliquely relative to each other. For example, the first filter 221 and the second filter 222 may be arranged obliquely relative to each other while forming an inclination angle α. For example, the inclination angle α between the first filter 221 and the second filter 222 may be 45 degrees. In other words, the first filter 221 may be a metal grid filter with a series of horizontal grid lines, and the second filter 222 may be a grid filter with a series of horizontal grid lines. The second filter 222 may be offset or rotated with respect to the first filter 221, such that the horizontal grid lines of the filters are placed with respect to each other by angle α. In other words, the first filter 221 and the second filter 222 may be rotationally offset by a predetermined angle. The first filter 221 and the second filter 222 are arranged obliquely relative to each other while forming an inclination angle, thereby facilitating the removal of secondary pollutants, such as silicon oxide, in the concentrated exhaust gas WGC (see FIG. 2) passing through the filter 220 (see FIG. 2).

FIG. 5 illustrates an example in which the filter 220 (see FIG. 2) includes two metal mesh grid filters, but this is for illustrative purposes only. The filter 220 may also include three or more metal mesh grid filters. In this case, the three or more metal mesh grid filters may be arranged obliquely relative to each other while each forming an inclination angle. For example, when the filter 220 (see FIG. 2) includes three filters, a first filter and a second filter may be arranged at an inclination angle of about 45 degrees, and the first filter and a third filter may be arranged at an inclination angle of about 30 degrees. For example, when the filter 220 (see FIG. 2) includes four filters, a first filter and a second filter may be arranged at an inclination angle of about 45 degrees, the first filter and a third filter may be arranged at an inclination angle of about 30 degrees, and the first filter and a fourth filter may be arranged at an inclination angle of about 22.5 degrees. In other words, the plurality of filters may be rotationally offset with respect to each other by at least one predetermined angle, and as described above, each filter may be rotationally offset with respect to another filter by a different angle, and/or various combinations thereof.

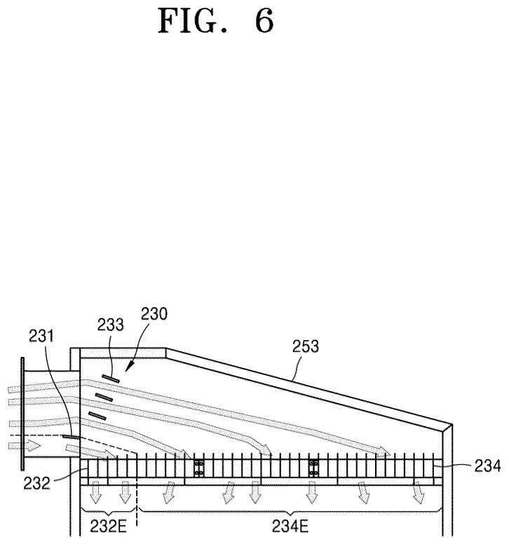

FIG. 6 is a cross-sectional view illustrating the airflow stabilizer 230 of the integrated catalytic reactor 202 according to one or more embodiments.

Referring to FIG. 6, the airflow stabilizer 230 may include a first guide vane 231, a plurality of second guide vanes 233, a plurality of first straighteners 232, and a plurality of second straighteners 234.

The first guide vane 231 may be oriented at an inclination angle of about 5 degrees relative to the bottom surface of the third frame 253. Each of the second guide vanes 233 may be at a higher vertical level than the first guide vane 231 and oriented at an inclination angle of about 20 degrees relative to the bottom surface of the third frame 253. The plurality of second guide vanes 233 may be arranged in the vertical direction while being spaced apart from each other in the vertical direction. One first guide vane 231 may be provided, and the plurality of second guide vanes 233 may be provided. For example, three second guide vanes 233 may be provided. The first guide vane 231 and the second guide vanes 233 may prevent deflection of the concentrated exhaust gas WGC (see FIG. 2) flowing into the airflow stabilizer 230 and may change the flow direction of the concentrated exhaust gas WGC (see FIG. 2) so that the concentrated exhaust gas WGC may flow uniformly into the catalytic assembly 240. For example, the first guide vane 231 may guide the flow direction of a relatively lower portion of the concentrated exhaust gas WGC (see FIG. 2) to a first straightener region 232E, and the second guide vanes 233 may change the flow direction of a relatively upper portion of the concentrated exhaust gas WGC (see FIG. 2) and guide the same to a second straightener region 234E. The concentrated exhaust gas WGC (see FIG. 2) may be uniformly guided to the first straightener region 232E and the second straightener region 234E by the first guide vane 231 and the second guide vanes 233, respectively.

The plurality of first straighteners 232 may be arranged in the first straightener region 232E. The plurality of first straighteners 232 may be arranged in the horizontal direction such that the first straighteners 232 are spaced apart from each other in the horizontal direction. Among the plurality of first straighteners 232, a first straightener 232 that is closer to the second straightener region 234E may have a greater vertical length than others. For example, the vertical length of the first straightener 232 farthest from the second straightener region 234E among the plurality of first straighteners 232 may be about 100 mm, and the vertical length of the first straightener 232 closest to the second straightener region 234E among the plurality of first straighteners 232 may be about 120 mm. Also, the vertical lengths of the first straighteners 232 arranged between the first straightener 232 farthest from the second straightener region 234E among the plurality of first straighteners 232 and the first straightener 232 closest to the second straightener region 234E among the plurality of first straighteners 232 may increase toward the first straightener 232 that is closest to the second straightener region 234E among the plurality of first straighteners 232.

The plurality of second straighteners 234 may be arranged in the second straightener region 234E. The plurality of second straighteners 234 may be arranged in the horizontal direction such that the second straighteners 234 are spaced apart from each other in the horizontal direction. The plurality of second straighteners 234 may have the same or substantially the same vertical length. The vertical length of each of the plurality of second straighteners 234 may be equal or substantially equal to the vertical length of the first straightener 232 that is closest to the second straightener region 234E among the plurality of first straighteners 232. For example, the vertical length of each of the plurality of second straighteners 234 may be about 120 mm, which is the same as the vertical length of the first straightener 232 closest to the second straightener region 234E among the plurality of first straighteners 232.

The plurality of first straighteners 232 and the plurality of second straighteners 234 may maintain a uniform flow speed of the concentrated exhaust gas WGC (see FIG. 2). For example, the concentrated exhaust gas WGC guided by the first guide vane 231 may collide with the plurality of first straighteners 232, and thus, the flow direction and the flow speed of the concentrated exhaust gas WGC may be adjusted. Also, for example, the concentrated exhaust gas WGC guided by the second guide vanes 233 may be corrected by the plurality of second straighteners 234, and thus, the flow speed of the concentrated exhaust gas WGC may be adjusted and the concentrated exhaust gas WGC may be evenly guided.

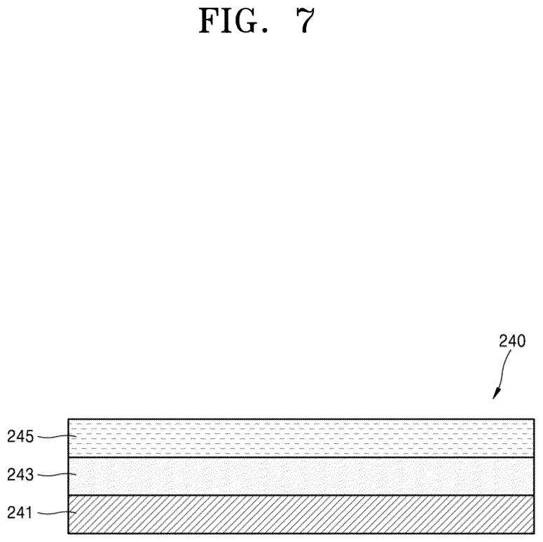

FIG. 7 is a cross-sectional view illustrating the catalytic assembly 240 of the integrated catalytic reactor 202 according to one or more embodiments.

Referring to FIG. 7, the catalytic assembly 240 may include a body 241, a first catalytic layer 243, and a second catalytic layer 245.

The body 241 may include, for example, a cordierite containing magnesium, aluminum, and silicon.

The first catalytic layer 243 may be disposed on the body 241, and the second catalytic layer 245 may be disposed on the first catalytic layer 243. The first catalytic layer 243 may remove organic materials, such as isopropyl alcohol, contained in the concentrated exhaust gas WGC (see FIG. 2), and alkaline materials, such as ammonia, contained in the concentrated exhaust gas WGC (see FIG. 2). In embodiments, the first catalytic layer 243 may include copper and platinum. The platinum contained in the first catalytic layer 243 may oxidize the organic materials, such as isopropyl alcohol, and alkaline materials, such as ammonia, thereby removing the organic materials and the alkaline materials from the concentrated exhaust gas WGC.

The second catalytic layer 245 may remove the alkaline materials, such as ammonia, contained in the concentrated exhaust gas WGC (see FIG. 2), and may reduce again the nitrogen oxide that may result from the oxidation of the alkaline materials, such as ammonia. In one or more embodiments, the second catalytic layer 245 may include copper and platinum. The platinum contained in the second catalytic layer 245 may oxidize the alkaline materials, such as ammonia, thereby removing the alkaline materials from the concentrated exhaust gas WGC. In addition, the copper contained in the second catalytic layer 245 may reduce again the nitrogen oxide that is oxidized from the alkaline material.

In one or more embodiments, the platinum content in the first catalytic layer 243 may be greater than the copper content in the first catalytic layer 243. In one or more embodiments, the platinum content in the second catalytic layer 245 may be less than the copper content in the second catalytic layer 245.

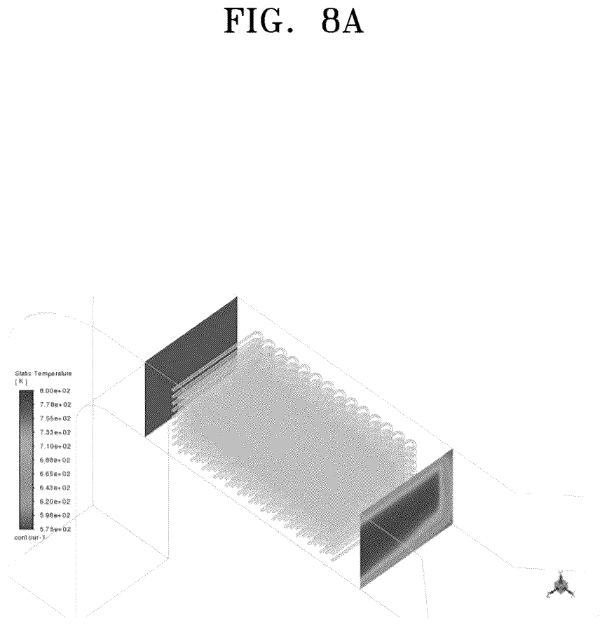

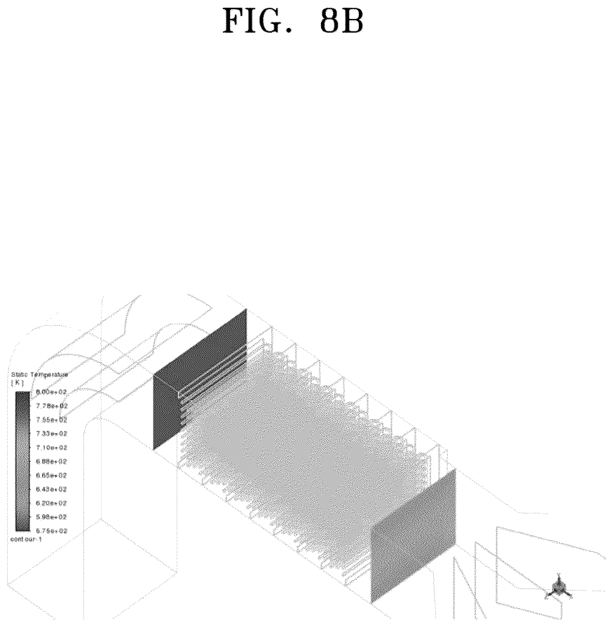

FIG. 8A is a diagram illustrating the results of a heat flow analysis of a heat source according to a comparative example, and FIG. 8B is a diagram illustrating the results of a heat flow analysis of a heat source according to one or more embodiments. Specifically, FIG. 8A is a diagram illustrating the results of heat flow analysis of the heat source according to the comparative example in which the vertical length of an electric heater of the heat source is less than the vertical length of an outlet of the heat source, and FIG. 8B is a diagram illustrating the results of heat flow analysis of the heat source according to one or more embodiments in which the vertical length of an electric heater of the heat source is equal to the vertical length of an outlet of the heat source.

Referring to FIG. 8A, in the comparative example, the central region of the outlet of the heat source has a relatively high temperature, but the edge region of the outlet of the heat source has a relatively low temperature. Therefore, it may be seen that the temperature distribution at the outlet of the heat source is not uniform. This is because, in the comparative example, the vertical length of the outlet of the heat source is greater than the vertical length of the electric heater of the heat source, and thus, the outlet of the heat source has a region that may not be warmed by the electric heater of the heat source.

Referring to FIG. 8B, on the other hand, it may be seen that, in one or more embodiments, the temperature distribution at the outlet of the heat source is uniform. This is because the vertical length of the outlet of the heat source is equal or substantially equal to the vertical length of the electric heater of the heat source, and thus, all regions of the outlet of the heat source are warmed by the electric heater of the heat source.

That is, referring to FIGS. 8A and 8B, in the comparative example, the temperature distribution at the outlet of the heat source is not uniform, and thus, the temperature of the exhaust gas flowing to the outlet of the heat source via the electric heater of the heat source may also be not uniform. However, in one or more embodiments, the temperature distribution at the outlet of the heat source is uniform, and thus, the temperature of the exhaust gas flowing to the outlet of the heat source via the electric heater of the heat source may also be uniform.

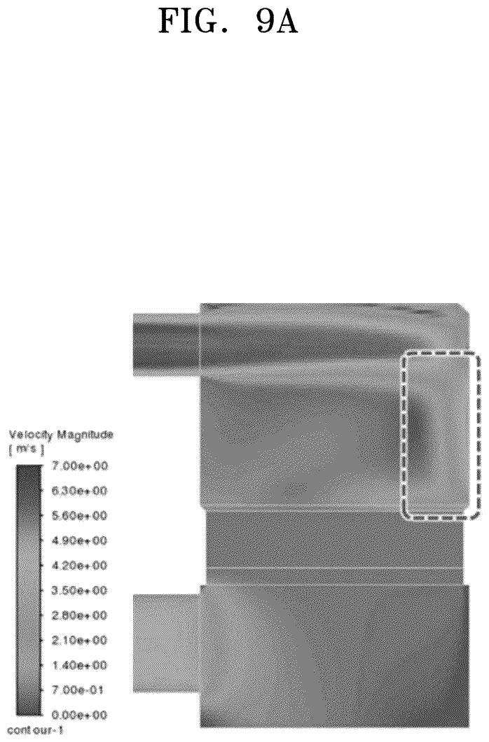

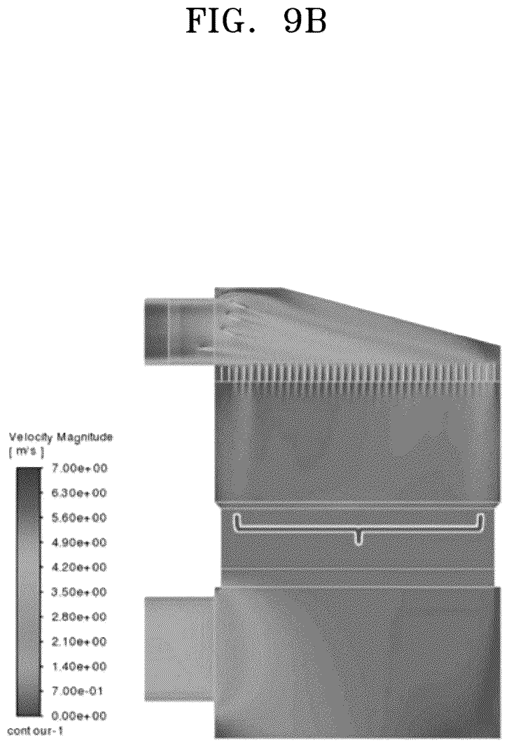

FIG. 9A is a diagram illustrating the results of a heat flow analysis of an airflow stabilizer according to a comparative example, and FIG. 9B is a diagram illustrating the results of a heat flow analysis of an airflow stabilizer according to one or more embodiments. In each of FIG. 9A and FIG. 9B, an electric heater is used as a heat source on the upstream side of the airflow stabilizer.

Referring to FIG. 9A, it may be seen that, in the comparative example, deflection of an exhaust gas passing through the airflow stabilizer occurs. This is because, in the comparative example, the airflow stabilizer does not include a separate guide vane, and thus, the exhaust gas passing through the airflow stabilizer is not spread uniformly.

Referring to FIG. 9B, on the other hand, it may be seen that the exhaust gas passing through the airflow stabilizer flows uniformly without any deflection. This is because the airflow stabilizer may include a guide vane, and thus, the exhaust gas passing through the airflow stabilizer is uniformly spread by the guide vane.

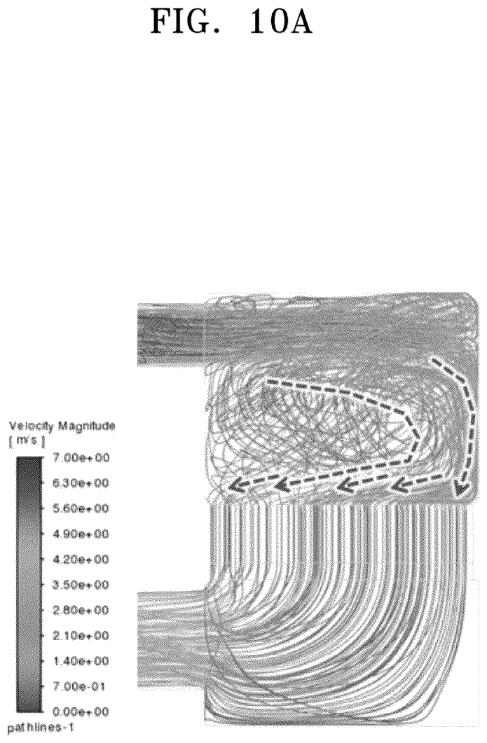

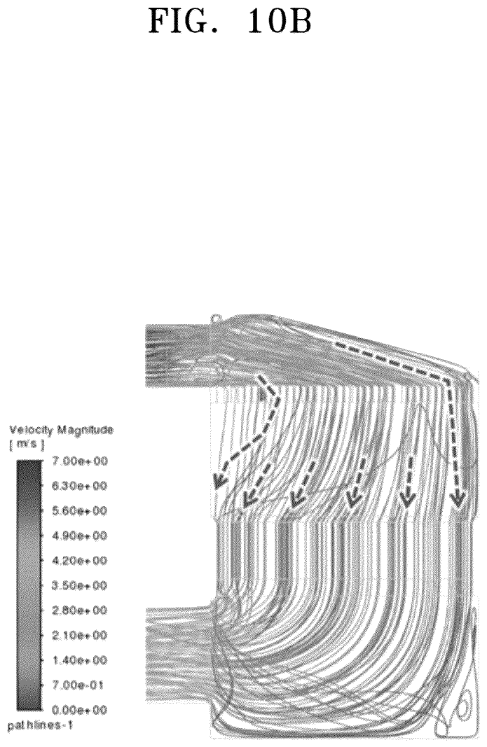

FIG. 10A is a diagram illustrating the results of an airflow analysis of the airflow stabilizer according to the comparative example, and FIG. 10B is a diagram illustrating the results of an airflow analysis of the airflow stabilizer according to the embodiments. In each of FIG. 10A and FIG. 10B, an electric heater is used as a heat source on the upstream side of the airflow stabilizer.

Referring to FIG. 10A, it may be seen that, in the comparative example, there is a deflection of the exhaust gas passing through the airflow stabilizer, and thus, the exhaust gas passing through the airflow stabilizer and entering the catalytic assembly flows in a direction oblique to a direction in which the upper surface of the catalytic assembly extends. This is because, in the comparative example, the airflow stabilizer does not include a separate guide vane, and thus, the exhaust gas passing through the airflow stabilizer is not spread uniformly.

Referring to FIG. 10B, on the other hand, it may be seen that the exhaust gas passing through the airflow stabilizer flows uniformly, and thus, the exhaust gas passing through the airflow stabilizer and entering the catalytic assembly flows in a direction substantially perpendicular to the direction in which the upper surface of the catalytic assembly extends. This is because the airflow stabilizer includes a guide vane, and thus, the exhaust gas passing through the airflow stabilizer is uniformly spread by the guide vane.

That is, referring to FIGS. 9A, 9B, 10A, and 10B, in the comparative example, there is a deflection of the exhaust gas after passing through the airflow stabilizer, and thus, the exhaust gas may not flow uniformly into the catalytic assembly. However, in FIGS. 9B and 10B, the exhaust gas that has passed through the airflow stabilizer flows uniformly, and thus, the exhaust gas may flow uniformly into the catalytic assembly.

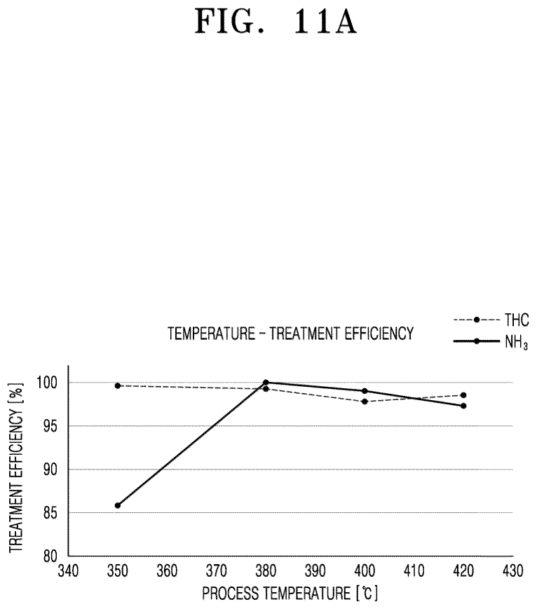

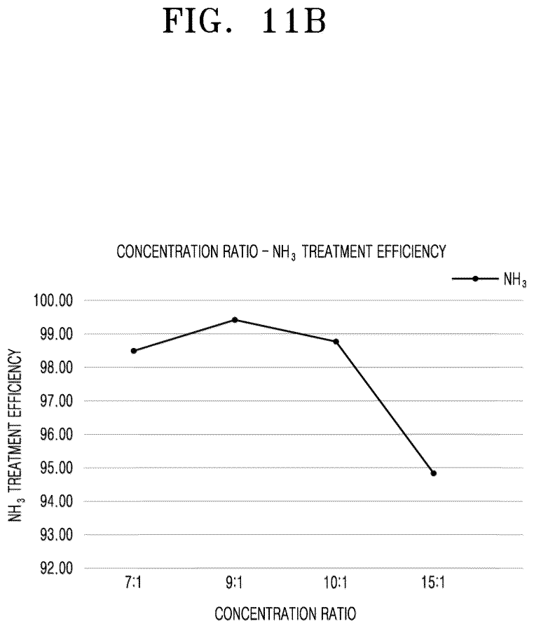

FIG. 11A is a graph illustrating treatment efficiency of a catalytic assembly for an exhaust gas according to an inlet temperature of the exhaust gas, according to one or more embodiments. In FIG. 11A, THC represents organic material in the exhaust gas, and NH₃ represents ammonia in the exhaust gas. Table 1 below shows the result values for the graph of FIG. 11A.

TABLE 1

| THC | | | | NH3 | | | |
|---|---|---|---|---|---|---|---|
| | | | Treat- | | | | Treat- |
| | Inlet | Outlet | ment | | Inlet | Outlet | ment |
| Temp. | Conc. | Conc. | Effic. | Temp. | Conc. | Conc. | Effic. |
| ° C. | ppm | ppm | % | ° C. | ppm | ppm | % |
| 350 | 139.0 | 0.6 | 99.57 | 350 | 99.0 | 14.0 | 85.86 |
| 380 | 105.0 | 0.8 | 99.24 | 380 | 88.0 | 0.0 | 100.00 |
| 400 | 72.0 | 1.6 | 97.78 | 400 | 61.0 | 0.6 | 99.02 |
| 420 | 127.0 | 2.0 | 98.43 | 420 | 29.0 | 0.8 | 97.24 |

Referring to FIG. 11A and Table 1, it may be seen that the catalytic assembly achieves excellent treatment efficiency for the organic materials contained in the exhaust gas in all temperature ranges in the graph of FIG. 11A and Table 1. Also, it may be seen that, when the temperature of the exhaust gas flowing into the catalytic assembly is in a range of about 380° C. to about 420° C., the catalytic assembly exhibits relatively high treatment efficiency for the ammonia contained in the exhaust gas, but when the temperature of the exhaust gas flowing into the catalytic assembly is in a range of about 350° C. to less than about 380° C., the catalytic assembly exhibits relatively low treatment efficiency for the ammonia contained in the exhaust gas.

FIG. 11B is a graph illustrating treatment efficiency of a catalytic assembly for an exhaust gas according to a concentration ratio of the exhaust gas, according to one or more embodiments. In FIG. 11B, the temperature of the exhaust gas flowing into the catalytic assembly is about 400° C. Table 2 below shows the result values for the graph of FIG. 11B.

TABLE 2

| Conc. Ratio | | 7:1 | 9:1 | 10:01 | 15:1 | |
|---|---|---|---|---|---|---|
| Inlet Conc. | ppm | 33.0 | 99.0 | 98.0 | 29.0 | (Based on NH₃) |
| Outlet Conc. | ppm | 0.5 | 0.6 | 1.2 | 1.5 | |
| Treatment Effic. | % | 98.48 | 99.39 | 98.78 | 94.83 | |
| Linear Vel. | m/s | 0.86 | 0.67 | 0.60 | 0.40 | |
| Spatial Vel. | /hr | 7,500 | 5,900 | 5,300 | 3,500 | |

Referring to FIG. 11B and Table 2, it may be seen that, when the concentration ratio of the exhaust gas flowing into the catalytic assembly is about 7:1 to about 10:1. That is, when the linear velocity of the exhaust gas flowing into the catalytic assembly is about 0.6 Am/s to about 0.86 Am/s, the treatment efficiency for the ammonia contained in the exhaust gas flowing into the catalytic assembly is relatively high, but when the concentration ratio of the exhaust gas flowing into the catalytic assembly is greater than about 10:1 to about 15:1. That is, when the linear velocity of the exhaust gas flowing into the catalytic assembly is about 0.4 Am/s to less than about 0.6 Am/s, the treatment efficiency of the catalytic assembly for the ammonia contained in the exhaust gas is relatively low.

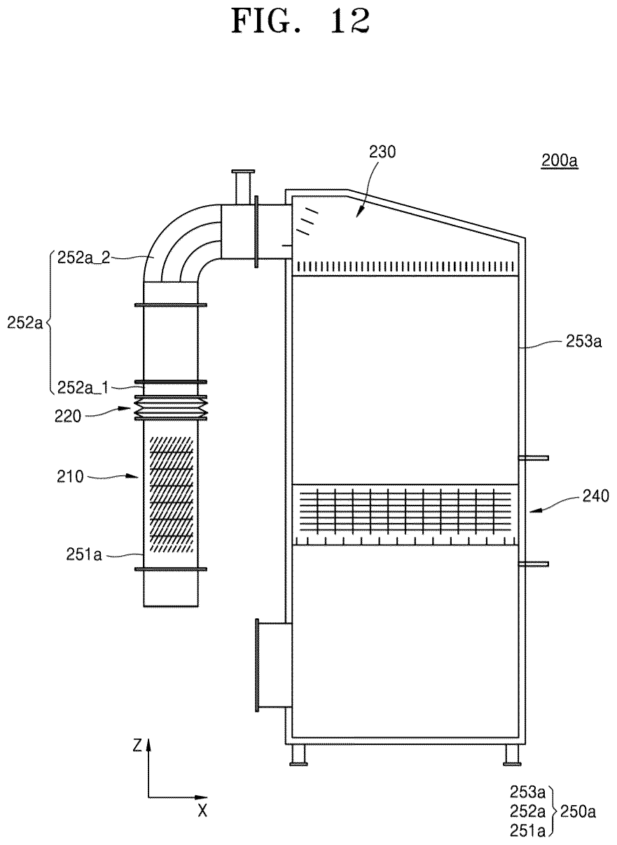

FIG. 12 is a cross-sectional view illustrating an integrated catalytic reaction system 200a according to one or more embodiments. Description of aspects that are the same as or similar to those described above may be omitted.

Referring to FIG. 12, an integrated catalytic reactor 202a in the integrated catalytic reaction system 200a may include a frame structure 250a that includes a first frame 251a extending in a vertical direction (e.g., the Z direction), a first sub-frame 252a_1 extending in the vertical direction (e.g., the Z direction), and a second sub-frame 252a_2 having an elbow shape. The integrated catalytic reaction system 200a may be substantially the same as or similar to the integrated catalytic reaction system 200 illustrated in FIG. 2, except that the integrated catalytic reaction system 200a does not include a heat exchanger.

The integrated catalytic reactor 202a may include the heat source 210, the filter 220, the airflow stabilizer 230, the catalytic assembly 240, and the frame structure 250a.

The frame structure 250a may have a shape obtained by rotating a squared C-shape by 90 degrees (e.g., a C-shape). The frame structure 250a may include the first frame 251a, a second frame 252a, and a third frame 253a. The first frame 251a may extend in the vertical direction (e.g., the Z direction). The heat source 210 may be located inside the first frame 251a. The second frame 252a may include the first sub-frame 252a_1 and the second sub-frame 252a_2. The first sub-frame 252a_1 may be spaced apart from the first frame 251a with the filter 220 therebetween. The first sub-frame 252a_1 may extend in the vertical direction (e.g., the Z direction). The second sub-frame 252a_2 may be connected to the first sub-frame 252a_1. The second sub-frame 252a_2 may have an elbow shape. The third frame 253a may extend in the vertical direction (e.g., the Z direction). The third frame 253a may be connected to the second sub-frame 252a_2. The airflow stabilizer 230 and the catalytic assembly 240 may be arranged inside the third frame 253a.

The first frame 251a in the frame structure 250a may extend in the vertical direction, the heat source 210 may be located inside the first frame 251a, and the filter 220 may overlap the heat source 210 in the vertical direction. Accordingly, compared to the case in which the heat source 210 and the filter 220 are arranged in the horizontal direction, the area required for installing the integrated catalytic reactor 202a may be reduced.

FIG. 12 illustrates that the integrated catalytic reaction system 200a does not include a heat exchanger, but embodiments are not limited thereto. For example, the integrated catalytic reaction system 200a may include a heat exchanger if necessary.

Each of the embodiments provided in the above description is not excluded from being associated with one or more features of another example or another embodiment also provided herein or not provided herein but consistent with the disclosure.

While the disclosure has been particularly shown and described with reference to embodiments thereof, it will be understood that various changes in form and details may be made therein without departing from the spirit and scope of the following claims.

What is claimed is:

1. An integrated catalytic reactor comprising:
a heat source configured to heat an exhaust gas comprising an organic material and an alkaline material;
a filter configured to filter a secondary pollutant in the exhaust gas that is heated by the heat source;
an airflow stabilizer configured to adjust a flow direction and a flow speed of the exhaust gas that is filtered by the filter; and
a catalytic assembly configured to at least partially remove the organic material and the alkaline material in the exhaust gas that flows into the catalytic assembly from the airflow stabilizer.

2. The integrated catalytic reactor of claim 1, wherein the heat source comprises an electric heater.

3. The integrated catalytic reactor of claim 2, wherein a vertical length of the electric heater in the heat source is substantially equal to a vertical length of an outlet of the heat source.

4. The integrated catalytic reactor of claim 1, wherein the heat source is configured to heat the exhaust gas to a temperature in a range of 380° C. to 420° C.

5. The integrated catalytic reactor of claim 1, wherein the filter comprises at least one of a metal mesh grid filter and a ceramic filter.

6. The integrated catalytic reactor of claim 5, wherein the filter comprises one to five metal mesh grid filters.

7. The integrated catalytic reactor of claim 6, wherein the filter comprises two to five metal mesh grid filters, and
wherein the two to five metal mesh grid filters are rotationally offset with respect to each other by at least one predetermined angle.

8. The integrated catalytic reactor of claim 1, wherein the airflow stabilizer comprises a first guide vane, a plurality of second guide vanes at higher vertical levels than a vertical level of the first guide vane, a plurality of first straighteners in a first straightener region and arranged in a horizontal direction, and a plurality of second straighteners in a second straightener region and arranged in the horizontal direction.

9. The integrated catalytic reactor of claim 8, wherein vertical lengths of the plurality of the first straighteners increase toward the second straightener region.

10. The integrated catalytic reactor of claim 8, wherein vertical lengths of the plurality of second straighteners are substantially equal.

11. The integrated catalytic reactor of claim 1, wherein the catalytic assembly comprises a body, a first catalytic layer on the body, and a second catalytic layer on the first catalytic layer,
wherein the first catalytic layer and the second catalytic layer comprise copper and platinum,
wherein a platinum content in the first catalytic layer is greater than a copper content in the first catalytic layer, and
wherein a platinum content in the second catalytic layer is less than a copper content in the second catalytic layer.

12. An exhaust gas integrated treatment system configured to treat an exhaust gas comprising an organic material and an alkaline material, the exhaust gas integrated treatment system comprising:
a concentrator configured to concentrate the exhaust gas; and
an integrated catalytic reaction system configured to at least partially remove the organic material and the alkaline material from the concentrated exhaust gas,
wherein the integrated catalytic reaction system comprises an integrated catalytic reactor comprising:
a heat source configured to heat the exhaust gas comprising the organic material and the alkaline material;
a filter configured to filter a secondary pollutant in the exhaust gas that is heated by the heat source;
an airflow stabilizer configured to adjust a flow direction and a flow speed of the exhaust gas that is filtered by the filter; and
a catalytic assembly configured to at least partially remove the organic material and the alkaline material in the exhaust gas that flows into the catalytic assembly from the airflow stabilizer.

13. The exhaust gas integrated treatment system of claim 12, wherein the integrated catalytic reaction system further comprises a heat exchanger connected to the integrated catalytic reactor.

14. The exhaust gas integrated treatment system of claim 12, wherein the concentrator and the integrated catalytic reaction system are in a multilayer structure.

15. The exhaust gas integrated treatment system of claim 12, wherein the heat source comprises an electric heater, and
wherein a vertical length of the electric heater in the heat source is substantially equal to a vertical length of an outlet of the heat source.

16. The exhaust gas integrated treatment system of claim 12, wherein the filter comprises at least one of a metal mesh grid filter and a ceramic filter.

17. The exhaust gas integrated treatment system of claim 12, wherein the airflow stabilizer comprises a first guide vane, a plurality of second guide vanes at higher vertical levels than the first guide vane, a plurality of first straighteners arranged in a first straightener region in a horizontal direction, and a plurality of second straighteners arranged in a second straightener region in a horizontal direction, and
wherein vertical lengths of the plurality of the first straighteners increase toward the second straightener region, and
wherein vertical lengths of the plurality of second straighteners are equal to each other.

18. The exhaust gas integrated treatment system of claim 12, wherein the catalytic assembly comprises a body, a first catalytic layer on the body, and a second catalytic layer on the first catalytic layer,
wherein the first catalytic layer and the second catalytic layer comprise copper and platinum,
wherein a platinum content in the first catalytic layer is greater than a copper content in the first catalytic layer, and
wherein a platinum content in the second catalytic layer is less than a copper content in the second catalytic layer.

19. The exhaust gas integrated treatment system of claim 12, wherein the integrated catalytic reactor comprises a frame structure, and
wherein the frame structure has an L-shape.

20. An integrated catalytic reactor comprising:
a heat source comprising an electric heater configured to heat an exhaust gas comprising an organic material and an alkaline material;
a filter configured to filter a secondary pollutant in the exhaust gas that is heated by the heat source;
an airflow stabilizer comprising a first guide vane configured to change a flow direction of the exhaust gas that is filtered by the filter, a plurality of second guide vanes at higher vertical levels than a vertical level of the first guide vane and configured to change the flow direction of the exhaust gas that is filtered by the filter, a plurality of first straighteners in a first straightener region and arranged in a horizontal direction, the plurality of first straighteners configured to adjust a flow speed of the exhaust gas, and a plurality of second straighteners in a second straightener region arranged in the horizontal direction, the plurality of second straighteners configured to adjust the flow speed of the exhaust gas; and
a catalytic assembly comprising a body, a first catalytic layer on the body and configured to at least partially remove the organic material and the alkaline material in the exhaust gas, and a second catalytic layer on the first catalytic layer and configured to at least partially remove the alkaline material in the exhaust gas.
